(19) United States
(12) Patent Application Publication
(10) Pub. No.: US 2006/0112204 A1
(43) Pub. Date: May 25, 2006

(54) Method for making a network formed by can type buses, a network and an apparatus having the network

(76) Inventor: Yann Casteignau, Choisel (FR)

Correspondence Address: CANTOR COLBURN, LLP, 55 GRIFFIN ROAD SOUTH, BLOOMFIELD, CT, 06002, US

(21) Appl. No.: 11/183,425

(22) Filed: Jul. 18, 2005

(30) Foreign Application Priority Data
Nov. 24, 2004 (FR) 04 52752

(51) Int. Cl. G06F 13/00; G06F 13/14

(52) U.S. Cl. 710/100; 710/305

(57) ABSTRACT

A method, a network and an apparatus having the network in which a star network is formed by CAN type buses using a repeater where each arm can be isolated from the other arms. CAN buses are connected to one another by means of the repeater that duplicates the signals observable on one bus on all the other buses connected to it. Communications circuits and/or controllers are connected to the repeater Depending on the reception signal received, the repeater organizes operations of sending transmission signals to the communications circuits and the controllers.

### CROSS-REFERENCE TO RELATED APPLICATIONS

This application claims the benefit of a priority under 35 USC 119(a)-(d) to French Patent Application No. 04 52752 filed Nov. 24, 2004, the entire contents of which is hereby incorporated by reference.

### BACKGROUND OF THE INVENTION

An embodiment of the present invention relates to a method for making a network formed by CAN (Control Area Network) type buses, and in particular, setting up a star network formed by CAN type buses using a repeater. An embodiment of the invention is a network and an apparatus having the network. The invention can be applied but not exclusively in the field of medical systems such as in a radiology apparatus, and in particular, an X-ray apparatus.

CAN type communications buses or CAN buses correspond to one of the standards used for electronic communications buses. Controllers associated with devices such as motors or actuators are connected to these buses to communicate with each other. These controllers manage signals that the device sends or receives on a bus. These controllers may either play a sender role and send a signal addressed to another controller of the bus, or play a receiver role and receive a signal sent by another controller. In one example, a controller is a microcontroller or a microprocessor, provided with memories, coupled to a CAN controller circuit.

Under the CAN bus standard, when a controller sends or receives signals on a bus, all the other controllers connected to this bus receive these signals. Furthermore, the signals observable on the bus encode priority numbers in an address zone. Thus, when a first controller sends a first signal associated with a first address and when, at the same time, a second controller sends a second signal associated with a second address, the sending operations are organized. Indeed, if the second address has a higher priority level than the first address, the second controller is authorized to send while the first controller will be authorized to send only after the second controller has finished sending.

There are known medical systems comprising CAN buses intended for obtaining mutual communication between different controllers connected to these buses and associated with devices.

FIG. 1 a shows a known X-ray apparatus 1 with a pedestal 2 to which an intermediate arm 3 is hooked by means of a first motor-driven link 4. A C-shaped arm 5 is hooked to the arm 3 by means of a second motor-driven link 6. Arm 5 has an X-ray emitter 7 as well as an X-ray detector 8 located on either side of a means for object support, such as medical table 9. An object, such as a patient (not shown) reclines on table 9 for the duration of an examination.

Table 9 has devices by which the patient can be spatially oriented during the examination. A device may, for example, be an operating handle or lever that controls the motor, or it may be the motor itself. Controllers 20-22 respectively associated with a lever and with the motors may communicate with each other by means of a CAN type bus 14. Although the bus 14 is represented here by only a line, bus 14 generally has two connections to provide for the transmission of differential signals.

Controllers 20-22 are located inside hollow metal frames 16-18. In the prior art, the standard for CAN buses lays down the definition of a main bus segment, in this case the bus 14, to whose ends two resistors are connected. This standard stipulates the connection of the controllers 20-22 to this main segment by means of segments 24-26 of connections. Segments 24-26 have a distance that is smaller, in a given ratio, than the length of the main bus segment 14. This means that the bus 14 must wind about within these armatures, in order to limit the length of the connection segments 24-26. Such a bus configuration therefore gives rise especially to a waste of connection.

Furthermore, in such a configuration, a connection problem may impair communications between all the controllers. If there is a break of a bus inside the frames 16-18, on one of the connection segments 24-26, the communication on the entire bus is cut off and the medical system becomes unusable.

If one of the controllers 20-22 is at a distance from the bus 14 greater than a limit distance, this controller can be connected to the bus 14 by means of a connection segment having one end connected to a termination resistor. The resistor prevents the segment from playing an antenna role relative to the bus 14. However, the resistor is perceived by the bus 14 as a resistor connected to it in parallel. Hence, the greater the number of segments included in the bus 14, the lower is the total impedance of the bus. Consequently, the controllers have their outputs connected almost in short-circuit and cannot let through enough current to send a signal on the bus 14.

There is commercially available CAN bus switches to duplicate signals on different buses. These switches are also known as gateways. However, in these switches or gateways, the signals undergo processing through software used by a microcontroller and they are reproduced after filtering by software on another bus. This software filtering causes a loss of time in the transmission of signals on a bus. Furthermore, the systems necessitate a programming of parameters to define buses on which signals will be duplicated. As a consequence, the signals observable on different buses connected to a switch or gateway may be different from one another.

### BRIEF DESCRPTION OF THE INVENTION

An embodiment of the invention is directed to overcoming a constraint dictated by the use of CAN type buses. In an embodiment of the invention, the CAN buses are connected to one another by means of a repeater. The repeater duplicates signals observable on one bus on all the other buses that are connected to it. There is then no longer any question of connection segments and main bus segments, since all the buses connected to the repeater are independent and behave as if they form one and the same bus.

Thus, a signal sent on one of the buses will be observable on all the other buses connected to the repeater. As a consequence, even if the buses are physically isolated from one another, they are virtually connected to a common bus and exchange signals by means of the repeater.

Furthermore, in an embodiment of the invention, the resistors connected to the ends of each bus are not seen as resistors parallel-connected by a controller. A large number of buses may therefore be connected to the repeater without any disturbance being caused, by the addition of a new bus, to communications between the other buses.

Furthermore, in an embodiment of the invention, the signals are processed in real time because the time taken by the repeater to process a signal is short and known. Indeed, the signals are duplicated in the different buses by means of logic elements made in an ASIC or an FPGA, whose switching time is known with precision. The latency time of the system formed by the repeater and all the buses connected to it are therefore always short and known, whereas the latency time of the system formed by a switch or gateway and all the buses connected to it is a changing latency.

An embodiment of the present invention relates to a method for making a network formed by CAN (Control Area Network) type buses. An embodiment of the invention relates to a method to make a star network formed by CAN buses using a repeater. The method comprising: first controllers connected to ends of the buses are linked to the repeater connected to all the buses, and a repeater reproduces the signals observable on each bus on all the other buses. An embodiment of the invention is a network and an apparatus having the network.

### BRIEF DESCRIPTION OF THE DRAWINGS

An embodiment of the invention will be understood more clearly from the following description and the accompanying figures. These figures are given by way of an example that in no way restricts the scope and extent of the invention. In the figures:

FIG. 1a is a schematic view, of a known network, already described, of an X-ray apparatus having a CAN bus;

FIG. 1b is a schematic view of a medical table comprising CAN buses connected to one another by means of a repeater according to an embodiment of the invention;

FIG. 2a is a schematic view of controllers connected to a repeater according to an embodiment of the invention either directly or by means of a CAN type bus;

FIG. 2b is a schematic view of a communications circuit;

FIG. 2c is a schematic view of a signal observable on a CAN bus; and

FIG. 3 is a state diagram of operation of the repeater made according to an embodiment of the invention.

### DETAILED DESCRIPTION OF THE INVENTION

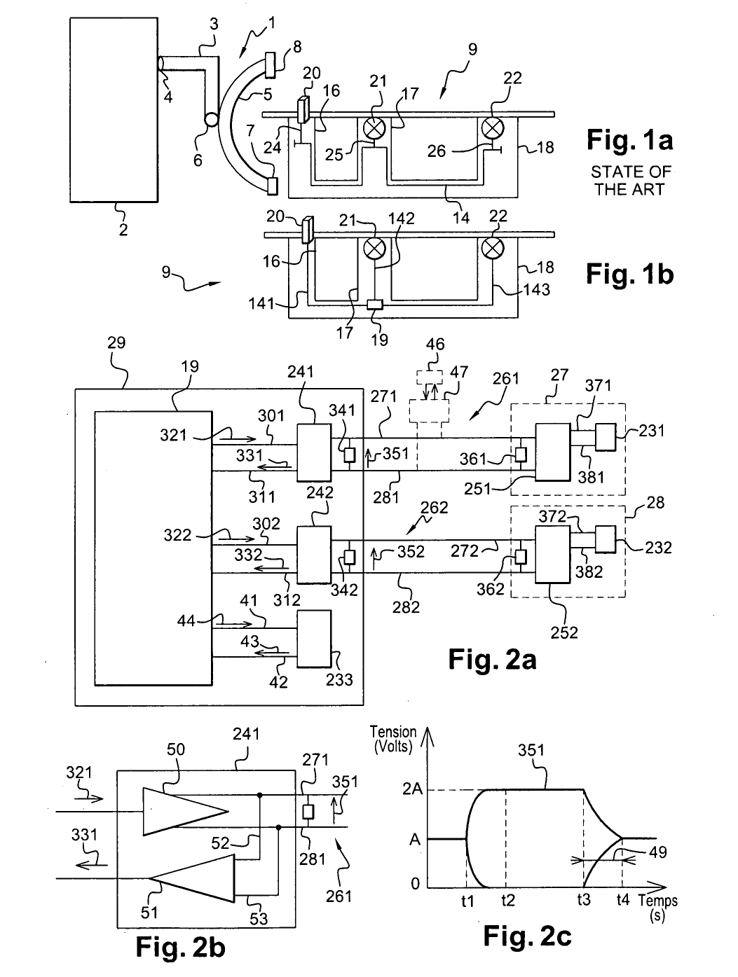

FIG. 1b is an embodiment of the invention in which three CAN type buses 141-143 respectively connect controllers 20-22 to a repeater 19. Repeater 19 reproduces the signals sent on one bus in the other buses. For example, when the controller 20 sends a signal on the bus 141, this signal is reproduced in the buses 142 and 143. The repeater 19 therefore enables the bus 14 to be replaced by three distinct buses 141-143. The different buses 141-143 behave as if they form only one and the same bus. The repeater organizes the sending of signals on these buses 141-143.

In this configuration, it is no longer necessary for the buses 141-143 to describe loops within each frame 16-18 in order to connect all the controllers 20-22 to one another. This bus configuration thus provides for savings in bus connection length.

Furthermore, when a break in connection occurs on a bus, an embodiment of the invention enables the other buses to still communicate with one another by means of the repeater 19. In this configuration, the buses 141-143 can be physically isolated from one another and the signals observable on these buses 141-143 are independent of one another. The architecture of the buses around the repeater 19 is also called a star architecture, by analogy with the shape that they may have around the repeater 19.

FIG. 2a shows a schematic view of first two controllers 231 and 232 connected to the repeater 19 by means of two CAN type buses 261 and 262 and a second controller 233 directly connected to the repeater 19.

In FIG. 2b, the buses 261 and 262 are two-way buses on which signals 351 and 352 are observable. Each of these buses 261 or 262 has a first communications circuit 241 or 242 and a second communications circuit 251 or 252. Each of these buses 261 or 262 furthermore has two resistors 341, 342 or 361, 362 that are situated at its ends and are parallel-connected electrically with connections 271, 272 or 281, 282 of the bus 261 or 262. These connections 271, 272 or 281, 282 link the first communications circuit to the second communications circuits or transceivers. In FIG. 2c, the communications circuits or transceivers generally carry out the conversion of a digital all-or-nothing signal into a physical transportation signal.

In this embodiment, each of the first communications circuits 241 or 242 is connected to the repeater 19 by means of two wire links 301, 311 or 302, 312. Each of the second communications circuits 251 or 252 is connected to one of the first controllers 231 or 232 by means of two links 371, 381 or 372, 382. The second controller 233 is directly connected to the repeater 19 by means of two connections 41 and 42.

First transmission signals 321-322 are sent by the repeater 19 to first communications circuits, and first reception signals 331-332 sent by these first communications circuits are received by the repeater 19. A second transmission signal 44 is sent by the repeater 19 to the second controller 233 and a second reception signal 43 is sent by the second controller 233 to the repeater 19.

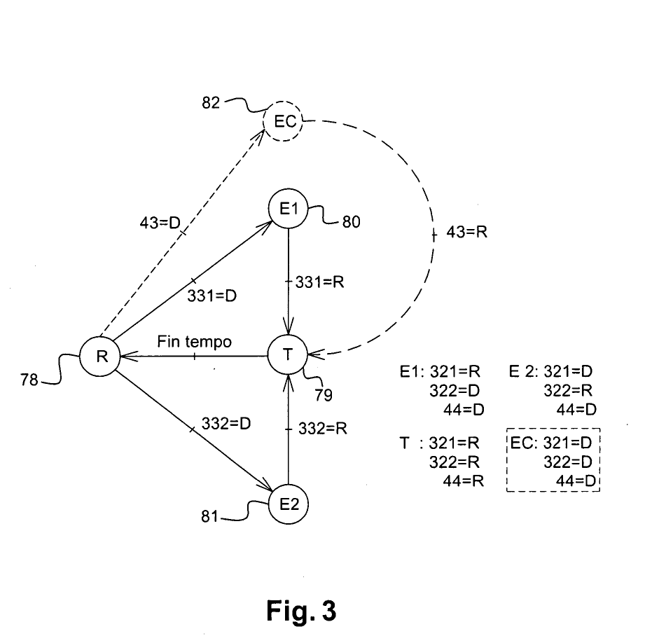

In FIG. 3, the repeater 19 organizes the sending of the transmission and reception signals to first communications circuits 241 and 242 and the second controller 233. This organization of the sending of signals is achieved so as to simulate the interconnection of the first controllers 231 and 232, and of the second controller 233 to a same bus.

As a variant embodiment, other controllers may be connected to the buses 261 or 262. For example, the controller 46 is connected to the bus 261 by means of a communications circuit 47.

In practice, each of the second controllers is physically assembled with the second communications circuit 251, 252 and the resistor 361, 362 corresponding to it on the electronic circuits 27 and 28. Furthermore, the repeater 19, the resistors 341-362, the first communications circuits 372, 373, and the second controller 233 may also be physically grouped together on one and the same electronic circuit 29.

FIG. 2b shows a detailed schematic view of the communications circuit 241, whose structure is substantially identical to that of the circuits 242, 251 and 252. The communications circuit 241 provides for two-way communications on the bus 261. The circuit 241 is capable of both sending the signal 321 on the bus 261, and receiving the signal 331 sent on the bus 261. Thus, the circuit 241 converts the all-or-nothing type transmission signal 321 into a transportation signal 351 and the transportation signal 351 into an all-or-nothing type reception signal 331. More specifically, when a transmission signal 321 is sent by the repeater on the bus 261, a first conversion element 50 converts this signal into a differential type of signal 351. Connections 52 and 53 pick up this signal and apply it to the terminals of a second conversion element 51. This second conversion element 51 then converts the differential voltage signal observable on the bus into a reception signal 331. Such a signal pick-up operation enables the repeater 19 that is connected to the circuit 241 to receive all the observable signals on the bus 261 including those that its sends itself. The repeater 19 can thus synchronies operations of sending transmission signals as a function of the other signals sent on the bus 261. The transmission and reception signals possess either a recessive level or a dominant level. A dominant level signal cannot be modified by a recessive level signal, while a recessive level signal can be modified by a dominant level signal. In general, in an idle state, a controller sends recessive level signals.

In one example, the communications circuit is an 82C250 type circuit. As a variant embodiment, the communications circuits carry out a conversion of all-or-nothing signals into optical or RF transportation signals.

FIG. 2c shows a shape of the differential signal 351 observable on the bus 261. This signal 351 is more specifically observable between the connections 271 and 281 of the bus 261. This signal 351 is of a differential type because the potentials of the two connections 271 and 281 measurable relative to a ground possess a same difference relative to a mean value A. At an initial instant for example, a signal 351 is observed with a voltage level of A volts at the terminals of the resistor 341. This voltage level A corresponds to a recessive level. At an instant t1, a dominant type of signal is sent on the bus 261. The voltage 351 then starts rising and, at an instant t2, it reaches a level 2*A corresponding to a dominant level. At the instant t2, one of the connections then has a potential of 2*A volts while the other has a potential of 0 Volts. At an instant t3, a recessive level signal is sent on the bus 261. The voltage 351 then falls and, at an instant t4, reaches a level corresponding to the recessive level.

There is a certain delay between the instant when a change in level is imposed on the signal and the instant when the signal reaches the requested level. This delay corresponds in fact to the charging or discharging of the capacitors used in the communications circuits or to parasitic capacitive effects introduced especially by cables or lugs of components. The duration needed for the signal to pass from a dominant level to a recessive level is called an overlapping period 49. During this overlapping period 49, the level of the signal observed on the bus cannot be detected with certainty.

FIG. 3 shows a state diagram corresponding to the implementation of the method according to an embodiment of the invention. In the following description, the term “sender” is understood to mean an element that is directly connected to the repeater 19 and sends a signal to this repeater 19, and the term “recipient” covers all the elements that are directly connected to the repeater 19, except for the transmitter. When the repeater 19 receives a dominant level reception signal from the transmitter, the repeater 19 sends out transmission signals whose level depends on the recipient and/or the transmitter.

More specifically, in a resting state 78, the reception signals 331, 332 and 43 received by the repeater 19 have recessive levels. When the receiver 19 receives a first dominant level reception signal 331 sent by the first communications circuit 241 (which is then a sender), it goes into a first state 80. In this state 80, the receiver 19 sends dominant level transmission signals 322 and 44 to all the recipients 242 and 233. This sending of dominant signals to the first communications circuit 242 and the second controller 233 makes it possible to simulate the fact that the controllers 231-233 are connected to the same bus. Furthermore, the receiver 19 sends a recessive level transmission signal 321 to the transmitter 241. This sending of a recessive level transmission signal 321 is aimed at preventing blocking in this first state 80. Indeed, if the signal 321 had a dominant level, the observable signal 351 on the bus 261 would constantly have a dominant level and no other controller 231-233 would then be authorized to send any dominant signal to the repeater 19.

The operations of sending signals to the sender 241 and recipients 242 and 233 by the repeater 19 take place as long as the sender 241 sends a dominant level signal 331. Furthermore, so long as the sender 241 sends a dominant level signal, the repeater 19 does not process the reception signals 332 and 43 sent by the recipients 233 and 242. This absence of processing also prevents a blocking of the system if the repeater 19 should receive only dominant level signals.

The repeater 19 comes out of the first state 80 and goes into a timeout step 79 when the sender 241 sends a recessive level signal 331 to the repeater 19. In the timeout step 79, the repeater 19 sends recessive level transmission signals to the recipients 242, 233 and the sender 241 during a timeout period. This timeout step 79 makes it possible to overcome any problems that the system could encounter when the level of the observable signals on the buses 261 and 262 is indeterminate. The timeout duration is at least as long as the overlapping period 48. This duration ranges from 0 ns to 700 ns, and is chosen as a function of a given application. When the timeout period has elapsed, the system returns to the idle step 78 when the repeater 19 is listening for dominant level signals that may be sent.

When the first communications circuit 242 becomes a sender in turn, the repeater 19 behaves with the recipients in a way that corresponds to the way in which it behaves when the first communications circuit 241 is a sender.

When the repeater 19 is in an idle state and receives a reception signal 43 sent by the second controller 233 (which then becomes the transmitter), it goes into a third state 82. In this third state 82, the repeater 19 sends dominant level transmission signals 321, 322 and 44 to all the recipients 241, 242 and the sender 233. The controller 233 directly connected to the repeater 19 thus receives a reception signal of a same level as the transmission signal that it is sending, so that it can organize operations of sending signals and still receive a signal 44 corresponding to the signals sent on the bus.

Here again, so long as the sender 233 sends a dominant level signal, the repeater 19 does not process the reception signals sent by the recipients 241, 242. The repeater 19 comes out of the state 82 when the controller 233 sends a recessive level signal 43 to the repeater 19. Then, as was done earlier, the repeater 19 goes into a timeout step 79. At the end of this step 79, the repeater 19 returns to the idle state 78.

In an exemplary embodiment of implementation, two first controllers (hence two first circuits 241 and 242), and only one second controller 233 are connected to the repeater 19. However, in the general case, an unspecified number of first controllers and an unspecified number of second controllers may be connected to the repeater 19.

As a variant embodiment, it is of course possible to connect only first controllers or only second controllers to the repeater 19.

In addition, while an embodiment of the invention has been described with reference to exemplary embodiments, it will be understood by those skilled in the art that various changes may be made in the function and/or way and/or result and equivalents may be substituted for elements thereof without departing from the scope and extent of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element or feature from another. Furthermore, the use of the terms a, an, etc. do not denote a limitation of quantity, but rather denote the presence of at least one of the referenced element or feature.

What is claimed is:

1. A method of making a network formed by CAN buses comprising:
providing a repeater;
connecting first controllers to ends of the buses that are linked to the repeater connected to all the buses; and
allowing the repeater to reproduce signals observable on each bus on all the other buses.

2. The method according to claim 1 wherein:
first controllers are connected to the repeater by means of buses connected to first communications circuits and to second communications circuits, the first communications circuits being connected directly to the repeater, the repeater being capable of sending first transmission signals to these first communications circuits and receiving first reception signals sent by the first communications circuits, and
second controllers are connected directly to the repeater, the repeater being capable of sending said transmission signals to second controllers and receiving second reception signals sent by the second controllers.

3. The method according to claim 2 wherein:
the controllers and the repeater are capable of sending and/or receiving dominant level or recessive level electrical signals, the recessive level signal being capable of being modified by a dominant level signal, and the dominant level being incapable of being modified by a recessive level signal.

4. The method according to claim 3 wherein:
when the repeater receives a dominant level reception signal sent by a sender, this sender being either one of the first communications circuits or one of the second controllers, the repeater sends a transmission signal to a set of recipients, these recipients being all the first communications circuits and the second controllers except for the sender, the level of this transmission signal being a function of the recipient and/or the sender.

5. The method according to claim 4 wherein:
when the sender is a first transmission circuit, then the repeater sends a dominant level transmission signal to all the recipients and a recessive level transmission signal to the sender, these sending operations taking place so long as the sender sends a dominant level signal.

6. The method according to claim 4 wherein:
when the sender is the second controller, then the repeater sends dominant level transmission signals to the recipients and the sender, these sending operations occurring so long as the sender sends a dominant level reception signal.

7. The method according to claim 4 wherein:
so long as the sender sends a dominant level signal, the repeater does not process the reception signals sent by the recipients.

8. The method according to claim 5 wherein:
so long as the sender sends a dominant level signal, the repeater does not process the reception signals sent by the recipients.

9. The method according to claim 6 wherein:
so long as the sender sends a dominant level signal, the repeater does not process the reception signals sent by the recipients.

10. The method according to claim 4 wherein:
as soon as the sender sends a recessive level reception signal, the repeater sends recessive level transmission signals to all the recipients and the sender during a timeout period.

11. The method according to claim 5 wherein:
as soon as the sender sends a recessive level reception signal, the repeater sends recessive level transmission signals to all the recipients and the sender during a timeout period.

12. The method according to claim 6 wherein:
as soon as the sender sends a recessive level reception signal, the repeater sends recessive level transmission signals to all the recipients and the sender during a timeout period.

13. The method according to claim 7 wherein:
as soon as the sender sends a recessive level reception signal, the repeater sends recessive level transmission signals to all the recipients and the sender during a timeout period.

14. The method according to claim 8 wherein:
as soon as the sender sends a recessive level reception signal, the repeater sends recessive level transmission signals to all the recipients and the sender during a timeout period.

15. The method according to claim 9 wherein:
as soon as the sender sends a recessive level reception signal, the repeater sends recessive level transmission signals to all the recipients and the sender during a timeout period.

16. The method according to claim 10 wherein:
the timeout period is made to last from 0 ns to 700 ns.

17. The method according to claim 11 wherein:
the timeout period is made to last from 0 ns to 700 ns.

18. The method according to claim 12 wherein:
the timeout period is made to last from 0 ns to 700 ns.

19. The method according to claim 13 wherein:
the timeout period is made to last from 0 ns to 700 ns.

20. The method according to claim 14 wherein:
the timeout period is made to last from 0 ns to 700 ns.

21. The method according to claim 2 wherein:
82C250 type communications circuits are used.

22. The method according to claim 3 wherein:
82C250 type communications circuits are used.

23. The method according to claim 4 wherein:
82C250 type communications circuits are used.

24. The method according to claim 5 wherein:
82C250 type communications circuits are used.

25. The method according to claim 6 wherein:
82C250 type communications circuits are used.

26. The method according to claim 7 wherein:
82C250 type communications circuits are used.

27. The method according to claim 10 wherein:
82C250 type communications circuits are used.

28. The method according to claim 16 wherein:
82C250 type communications circuits are used.

29. The method according to claim 1 wherein:
the architecture of the buses around the repeater is a star architecture, by analogy with the shape that they may have around the repeater.

30. The method according to claim 2 wherein:
the architecture of the buses around the repeater is a star architecture, by analogy with the shape that they may have around the repeater.

31. The method according to claim 3 wherein:
the architecture of the buses around the repeater is a star architecture, by analogy with the shape that they may have around the repeater.

32. The method according to claim 4 wherein:
the architecture of the buses around the repeater is a star architecture, by analogy with the shape that they may have around the repeater.

33. The method according to claim 5 wherein:
the architecture of the buses around the repeater is a star architecture, by analogy with the shape that they may have around the repeater.

34. The method according to claim 6 wherein:
the architecture of the buses around the repeater is a star architecture, by analogy with the shape that they may have around the repeater.

35. The method according to claim 7 wherein:
the architecture of the buses around the repeater is a star architecture, by analogy with the shape that they may have around the repeater.

36. The method according to claim 10 wherein:
the architecture of the buses around the repeater is a star architecture, by analogy with the shape that they may have around the repeater.

37. The method according to claim 16 wherein:
the architecture of the buses around the repeater is a star architecture, by analogy with the shape that they may have around the repeater.

38. The method according to claim 21 wherein:
the architecture of the buses around the repeater is a star architecture, by analogy with the shape that they may have around the repeater.

39. A network formed by CAN buses comprising:
a repeater;
first controllers connected to ends of the buses that are linked to the repeater connected to all the buses; and
allowing the repeater to reproduce signals observable on each bus on all the other buses.

40. The network according to claim 39 comprising:
first controllers connected to the repeater by means of buses connected to first communications circuits and to second communications circuits, the first communications circuits being connected directly to the repeater, the repeater being capable of sending first transmission signals to these first communications circuits and receiving first reception signals sent by the first communications circuits, and
second controllers connected directly to the repeater, the repeater being capable of sending said transmission signals to second controllers and receiving second reception signals sent by the second controllers.

41. A radiology apparatus comprising:
means for support of an object;
means for controlling the spatial orientation of the means for support;
CAN type buses for communicating with and between the means for controlling; and
a repeater for connecting the CAN type buses to one another.

42. The apparatus according to claim 41 comprising:
first controllers connecting to ends of the buses that are linked to the repeater connected to all the buses; wherein the repeater reproduces signals observable on each bus on all the other buses.

43. The apparatus according to claim 42 wherein:
first controllers are connected to the repeater by means of buses connected to first communications circuits and to second communications circuits, the first communications circuits being connected directly to the repeater, the repeater being capable of sending first transmission signals to these first communications circuits and receiving first reception signals sent by the first communications circuits, and
second controllers are connected directly to the repeater, the repeater being capable of sending said transmission signals to second controllers and receiving second reception signals sent by the second controllers.

44. The apparatus according to claim 41 wherein:
the architecture of the buses around the repeater is a star architecture, by analogy with the shape that they may have around the repeater

45. The apparatus according to claim 42 wherein:
the architecture of the buses around the repeater is a star architecture, by analogy with the shape that they may have around the repeater

46. The apparatus according to claim 43 wherein:
the architecture of the buses around the repeater is a star architecture, by analogy with the shape that they may have around the repeater
